(19) United States
(12) Patent Application Publication
(10) Pub. No.: US 2006/0015925 A1
(43) Pub. Date: Jan. 19, 2006

(54) Sales presentation video on demand system

(75) Inventor: James D. Logan, Candia, NH (US)

Correspondence Address: CHARLES G. CALL, 68 HORSE POND ROAD, WEST YARMOUTH, MA, 02673-2516, US

(73) Assignee: Gotuit Media Corp, Andover, MA (US)

(21) Appl. No.: 11/223,179

(22) Filed: Sep. 9, 2005

Related U.S. Application Data
(63) Continuation-in-part of application No. 10/165,587, filed on Jun. 8, 2002.
(63) Continuation-in-part of application No. 09/536,969, filed on Mar. 28, 2000, now Pat. No. 6,931,451.
(63) Continuation-in-part of application No. 10/060,001, filed on Jan. 29, 2002.
(63) Continuation-in-part of application No. 10/769,383, filed on Jan. 31, 2004.
Application No. 10/769,383 is a continuation-in-part of application No. 10/165,587, filed on Jun. 8, 2002.
(60) Provisional application No. 60/297,204, filed on Jun. 8, 2001.
(60) Provisional application No. 60/352,788, filed on Nov. 28, 2001.
(60) Provisional application No. 60/304,570, filed on Jul. 11, 2001.
(60) Provisional application No. 60/336,602, filed on Dec. 3, 2001.

(51) Int. Cl. H04N 5/445; H04N 7/173; H04N 7/16; G06F 13/00

(52) U.S. Cl. 725/135; 725/105; 725/39

(57) ABSTRACT

A system for replaying a sales presentation television program using a video on demand (VOD) or digital video recording (DVR) system. Metadata is created that subdivides the original broadcast into segments, and associates descriptive information with each segment. Playlists that specify an ordered subsequence of the sequence may be selected and used to present a variety of expanded or condensed versions of the sales presentation program originally broadcast to a viewer. Navigation controls including segment and subsegment lists, specially formatted screen displays, and special functions under the control of a user-operated remote control, facilitate the interactive selection and control of the presentation.

### CROSS REFERENCE TO RELATED APPLICATIONS

This application is a continuation in part of and claims the benefit of the effective filing date of, U.S. patent application Ser. No. 10/165,587 filed on Jun. 8, 20002 entitled “Audio and Video Program Recording, Editing and Playback Systems using Metadata” published as Patent Application Publication No. 2003/0093790. Application Ser. No. 10/165,587 claimed the benefit of the filing date of the following Provisional U.S. Patent Applications: Ser. No. 60/297,204 filed Jun. 8, 2001, Ser. No. 60/352,788 filed on Nov. 28, 2001, Ser. No. 60/304,570 filed on Jul. 11, 2001, and Ser. No. 60/336,602 filed on Dec. 3, 2001. Application Ser. No. 10/165,587 was also a continuation in part of U.S. patent application Ser. No. 09/536,969 filed Mar. 18, 2000 and a continuation in part of U.S. patent application Ser. No. 10/060,001 filed Jan. 29, 2002.

This application is also a continuation in part of and claims the benefit of the effective filing date of, U.S. patent application Ser. No. 10/769,383 filed by James D. Logan et al on Jan. 31, 2004 entitled “Methods and apparatus for recording and replaying time-shifted broadcast programming using visually displayed options,” which was a continuation in part of the above noted U.S. patent application Ser. No. 10/165,587.

This application is related to U.S. Pat. No. 5,892,536 issued Apr. 6, 1999 to James D. Logan et al. and entitled “Systems and Methods for Computer Enhanced Broadcast Monitoring”; U.S. Pat. No. 5,986,692 issued Nov. 19, 1999 to James D. Logan et al. and entitled “Systems and Methods for Computer Enhanced Broadcast Monitoring”; and to U.S. Pat. No. 6,088,455 issued Jul. 11, 2000 to James D. Logan et al. and entitled “Systems and Methods for Modifying Broadcast Programming.”

This application incorporates by reference the disclosures of each of the foregoing applications, application publications, and issued patents.

### FIELD OF THE INVENTION

This invention relates to audio and video program production, transmission, recording and playback systems.

### BACKGROUND OF THE INVENTION

The present invention belongs to a family of related systems that use metadata to control the playback of broadcast programming as disclosed in the previously issued patents and published patent applications summarized below. The disclosures of each of the following patents and published applications are hereby incorporated herein by reference.

U.S. Reissue Pat. No. Re36,801 issued to James D. Logan et al. on Aug. 1, 2000 entitled “Time delayed digital video system using concurrent recording and playback” describes a mechanism for continually storing live television or radio broadcast programs in an addressable digital memory and playing back the broadcast program after a variable delay period under the control of the viewer, permitting the viewer to pause, replay, and fast-forward (skip) live programming.

U.S. Pat. Nos. 5,892,536 and 5,986,692 issued to James D. Logan et al. describe systems which employ metadata to selectively store, manipulate and playback broadcast programming. Some of the arrangements and features disclosed in those two patents may be summarized as follows:

1. A remote editing station, which may be at the broadcast facility or at a remote location, classifies, describes or otherwise identifies individual segments of broadcast programming and sends metadata (sometimes referred to as “markup data”) identifying and describing those segments to a remote client receiver. For example, the markup data may identify individual segments by specifying the source and the time of the original broadcast, or by specifying some other unique characteristic of the broadcast signal. The program segments may be TV, radio, or Internet programs, or portions of programs, including individual songs, advertisements, or scenes.

2. The communication link used to transmit the metadata to the client may take one of several forms, including the Internet, a dialup telephone link, the communications pathway used to carry the broadcast signals to the client, or other forms of communication used to transport the metadata to the client.

3. At the client receiver, the metadata is used to identify particular program segments that may then be manipulated in one or more of a variety of ways. For example, the metadata may be used to selectively play back or record particular segments desired by the user; to re-sequence the identified segments into a different time order; to “edit-out” undesired portions of identified segments; to splice new information, such as computer text or advertising, into identified segments for rendering with the program materials, or to substitute different material (e.g. dubbing in acceptable audio to replace profanity to make programming more acceptable to minors).

4. The client receives and locally stores incoming broadcast programming and uses the markup data to identify desired segments within the stored program materials. The local storage mechanism may advantageously include means for concurrently recording live broadcasting while replaying a delayed version of the previously recorded programming as described in U.S. Reissue Pat. No. 36,801 issued to James D. Logan et al.

5. The markup data can provide a detailed “electronic program guide” to the broadcast programming previously received and stored in a personal video recorder (PVR) or digital video recorder (DVR) or an audio storage device, permitting the user to selectively play back a desired segment or portion of the programming previously recorded.

6. The markup data may be used to create a recorded collection of desired segments extracted from the buffered broadcast, allowing the desired segments to be saved while the remainder of the buffered materials is discarded to conserve recording space.

7. Special markup signals may be selectively sent to individual subscribers based on his or her indicated preferences so that only preferred program segments are identified and processed. For example, a subscriber might request markup data only for sports and news.

U.S. Pat. Nos. 5,271,811, 5,732,216, and 6,199,076, and co-pending application Ser. No. 09/782,546 filed on Feb. 13, 2001, by James D. Logan et al. describe a program distribution system which incorporates the following features:

1. A host system organizes and transmits program segments to client subscriber locations.

2. A scheduling file of metadata (a “playlist”) schedules the content and sequence of a playback session, which may then be modified by the user.

3. The content of the scheduled programming is varied in accordance with preferences associated with each subscriber.

4. Program segments are associated with descriptive subject matter segments, and the subject matter segments may be used to generate both text and audio cataloging presentations to enable the user to more easily identify and select desirable programming.

5. A playback unit at the subscriber location reproduces the program segments received from the host and includes mechanisms for interactively navigating among the program segments, including jumping from segment to segment in both forward and reverse directions.

6. A usage log is compiled to record the subscriber's use of the available program materials, to return data to the host for billing, to adaptively modify the subscriber's preferences based on actual usage, and to send subscriber-generated comments and requests to the host for processing.

7. Voice input and control mechanisms included in the player allow the user to perform hands-free navigation of the program materials and to dictate comments and messages, which are returned to the host for retransmission to other subscribers.

8. The program segments sent to each subscriber may include advertising materials, which the user can selectively play to obtain credits against the subscriber fee.

U.S. Patent Application Publication No. 2002/0120925 A1 published on Aug. 29, 2002 (based U.S. application Ser. No. 10/060,001 filed by James D. Logan et al. on Jan. 29, 2002) entitled “Audio and Video Program Recording, Editing and Playback Systems Using Metadata” describes structures and functions used to provide metadata control over the recoding, editing and playback of audio and video programming, including the use of mechanisms at the user's location for creating metadata which may be used in combination with metadata provided by an external source, for editing metadata in various ways at the user's location, for automatically responding to user activity to generate new metadata which characterizes the user's preferences and which serves to automatically identify and describe (or rate) programming segments, and for responding in numerous ways to the available metadata to enhance the utility and enjoyment of available broadcast materials.

U.S. Patent Application Publication No. 2003/0093790 A1 published on May 15, 2003 (based U.S. application Ser. No. 10/165,587 filed by James D. Logan et al. on Jun. 8, 2002) entitled “Audio and Video Program Recording, Editing and Playback Systems Using Metadata” describes systems for utilizing metadata created either at a central location for shared use by connected users, or at each individual user's location, to enhance user's enjoyment of available broadcast programming content. A variety of mechanisms are employed for automatically and manually identifying and designating programming segments, associating descriptive metadata which the identified segments, distributing the metadata for use at client locations, and using the supplied metadata to selectively record and playback desired programming.

### SUMMARY OF THE INVENTION

The present invention takes the form of methods and apparatus for presenting information and offers relating to objects such as homes and cars, antiques, retail products and other goods, as well as services, such as restaurants, travel services and events, that are being offered for sale in ways that may be interactively selected and controlled by a viewer. Although many of the techniques to be described are used to provide information relating to real estate offerings, it should be understood that most of these techniques can in most cases be applied to other goods and services as well. For example, in addition to presenting real estate properties in broadcast real estate sales presentation, the principles of the invention may be used to more effectively offer new or used vehicles in an automobile buying guide sales presentation, restaurants in a television dining guide, travel locations in a television vacation guide, upcoming sports events, concerts and other attractions in a televised event planning guide, and many others.

In this system, the content of a sales presentation is recorded in a storage device which can be accessed by and controlled by the viewer, such as a program storage device in a cable or satellite VOD (video on demand) service, or in a DVR or nDVR (network digital video recorder) systems as described under “Platforms,” below. In addition, supplemental program content which relates to a broadcast sales presentation may be made available to the viewer. For example, for example, in the case of real estate sales, map and GIS information relating to the location of each property, information concerning schools and demographics, etc. may be provided on demand when the viewer requests it.

In the description that follows, user functions are typically selected using a hand held remote control unit (which may hereinafter be referred to simply as a “remote”), often from menu selections or other visual indicators presented on a conventional television monitor screen; however, voice commands, touch screens, or other input means, may also be used. Personal computer (PC) systems which are connected to the television set or set top box, and connected to a server by some mechanism such as a Web interface, may be used to retrieve metadata and media content, set up user preferences, make catalog selections, and/or set up system parameters. When a remote or other device employing “buttons” is used, the manner in which buttons are associated with functions can play an important role in making the user interface intuitively easy to use.

Metadata created either automatically or by human editors before or after a continuous sales presentation broadcast is produced, but before the playback of that broadcast, is employed to identify the starting and ending points of segments of the stored broadcast and supplemental programming. Additional metadata in the form of “playlists” may be used to selectively play back selected sequences of these segments for the viewer, potentially in a different order than the sequence in which the segments were originally broadcast or recorded. In addition, the user is presented with a segment selection guide which is displayed to the viewer and which enables the user to selectively control which segments, or which sequence of segments (playlists), are reproduced. The metadata will typically be created as early as possible, but in some cases some supplemental metadata, such as rating data contributed by other viewers and sales history and pricing information that may be frequently updated, will become available for any given segment after the sales presentation is broadcast.

Today there are several TV programs and digital channels featuring a linear presentation of houses, cars, antiques, products and services for sale. Because the viewer cannot navigate the live video, and each viewer watching the presentation sees the same program content presented on each thing being offered, the producers' natural inclination is to keep each segment short. The result is that the channels end up being teasers about what is for sale, and a lure to go to a particular retailer, car dealer or real estate listing agent to find out more information.

If the video information presented was personalized (by allowing each viewer to access only those categories of interest, be it by price range, locale, etc.) and if navigation of the video was offered, viewers would be able to obtain information they need to make an informed buying decisions about selected offerings of interest to that viewer. By the same token, owners and listing agents would be more willing to offer their wares via a video on demand (VOD) television channel if potential buyers could be moved further along the buying cycle.

In the preferred VOD commerce system described below, a “Houses for Sale” system provides an example of one type of merchandise for sale. While some of the features of the preferred embodiment are specially adapted for real estate sales, others may be used to advantage to provide information on other types of products and services.

Preferred embodiments of employ a novel method for presenting a televised sales presentation broadcast by first recording a sales presentation to create a video program stored in a program storage device, the recorded sales presentation including a plurality of program segments each of which describes a particular object, product or service that is being offered by one or more vendors. Next, metadata is created that identifies and describes each of the stored program segments and the metadata is transmitted to a presentation device such as a television set top box or DVR which is used with a conventional television set. The presentation device then displays a segment guide which identifies at least selected ones of the program segments. A control device (typically a hand held remote control) is operated by a viewer to select one of the segments listed in the program guide. The selected segment is obtained from storage (either on local storage in a DVR or in network storage in an nDVR or VOD system), and transmitted to the presentation device for display. In this way, the viewer can select and review that portion of a sales presentation that is devoted to a particular object, product or service of particular interest.

The system may further store a group of one or more metadata playlists, each of which identifies a different plurality of segments of the recorded sales presentation program. A playlist guide displaying a description of each playlist in the group is displayed and the viewer can select and activate a particular playlist in the group, ant the segments identified by the selected playlist are then played back continuously, or the viewer can select specific objects, products or services to view from the playlist. The playlist typically identify fewer than all of the segments of the entire recorded sales presentation, thus permitting the viewer to see a condensed version of the sales presentation that is devoted to objects, products or services of particular interest to that viewer.

Each of the program segments may be further subdivided into subsegments, and additional metadata identifies and describes each of subsegments. The system may then display, for any selected segment, a subsegment guide that permits the viewer to replay a selected kind of information about each object, product or service being offered. For example, when the sales presentation offers real estate properties for sale or rent, the viewer may select a particular property using the segment guide and they jump immediately to that portion of the sales presentation that shows the interior of that property.

On request, the presentation device may switch between a normal full screen presentation of the currently playing segment in the form originally broadcast, or may display a composite image consisting of a reduced size video image area for reproducing the video content and a segment guide area displaying text descriptions or graphical representations of the object, product or service described by each of a plurality of said segments. Using a control device, the user may identify a particular segment listed in the segment guide area to cause the system to display the corresponding selected segment in the video image area. The video image area occupies only a portion of said display screen and the segment guide area occupies an area of said display screen outside said video image area. Alternatively, the segment guide may be overlaid on top of the video image.

These and other features and advantages of the present invention may be better understood by considering the following detailed description that follows. In the course of this description, frequent reference will be made to the attached drawings.

### BRIEF DESCRIPTION OF THE DRAWINGS

FIG. 1 shows a full screen presentation on a video presentation device of a real estate sales presentation including a segment guide identifying individual properties being offered along the left side of the display screen;

FIG. 2 is a block diagram of the principle components used in an illustrative hardware system for implementing one embodiment of the invention.

### DETAILED DESCRIPTION

Platforms

The system for recording and playing sales programming may be used on a variety of different platforms:

1. A Video on Demand (VOD) system with storage at the headend and where viewing would be totally time-shifted; that is, the sales programming would be stored in its entirety in a VOD video server before being made available to subscribers.

2. A networked Digital Video Recording (nDVR) system where the storage is again at the headend and viewing might be only partially time-shifted (that is, the sales programming may still be in progress as the viewer begins to view the game, normally from the start, on a delayed basis).

3. A Digital Video Recorder (DVR), where the storage is local and the sales programming may be partially or totally time-shifted. DVR capabilities may be built into a cable network set top box or a DVD player.

4. An Satellite Video on Demand system where content is specifically broadcast in order to be placed in storage at the subscriber's location, typically in a DVR that may be incorporated into a satellite receiver. The satellite provider may choose which programs are downloaded, often during nighttime hours so that they will be available to viewers on demand the following day (and thereafter until deleted).

The Viewer Interface

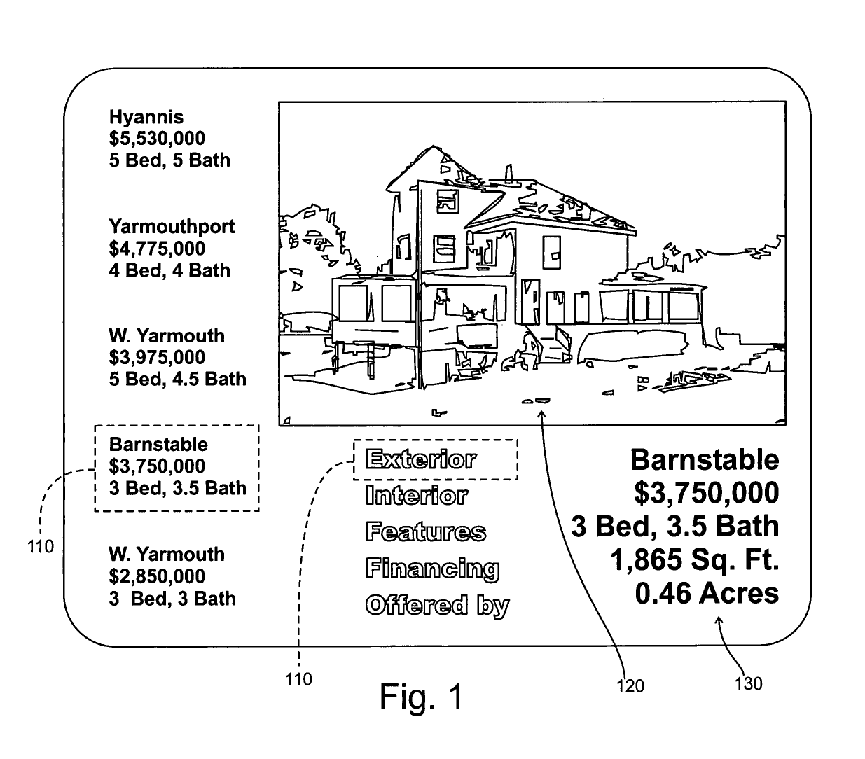

The interface presented to the viewer by the extended-capability VOD, DVR, or nDVR system using one of the platforms noted above includes a conventional television display presentation of an on-screen program navigation menu (such as the menu seen at 110 in FIG. 1) as well as the presentation of a segment index as illustrated at 115 in FIG. 1. These on-screen menus and indices may transparently overlays the content of the normal programming whenever a “segment guide” button is pressed on the remote control unit, or be selected from a menu of other options. Alternatively, when the segment guide is launched, the portion of the display showing content is shrunk as shown at 120 in FIG. 1, providing room at the left for an index list of segment labels at 115 and an “information pane” which may show additional information as illustrated at 130 or which may include a menu such as illustrated at 110. Additional information on the organization and content of these screen displays will be discussed in more detail below, following a brief description of a typical hardware environment used in an illustrative embodiment of the invention.

A Personal Video Recorder Implementation

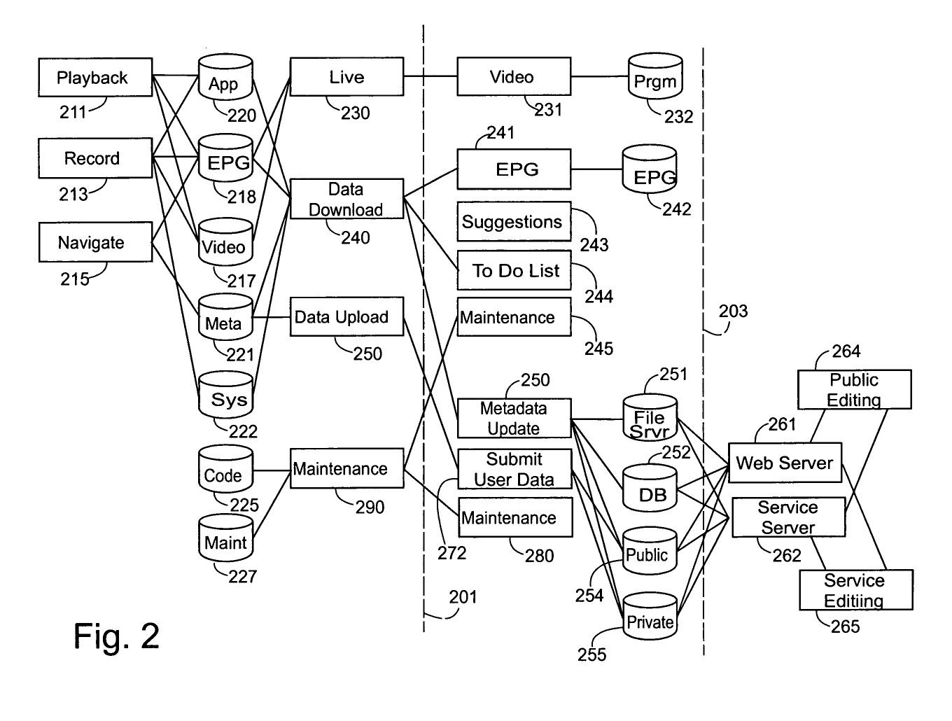

FIG. 2 of the drawings shows the principal data flow paths in a preferred implementation of the present invention which extends the capabilities of a DVR. The invention may also be implemented using a Network Digital Video Recorder (NDVR) in which video programming is stored at a network node and fed to the client device on demand, with pause, replay, fast-forwarding controls being provided to the viewer simulating the capabilities provided using a DVR's local storage. As shown in FIG. 2, the DVR performs the data storage and manipulation functions shown at the left of the vertical dashed line 201. Remote data storage and manipulation services are performed as shown in the middle of FIG. 2 between the vertical line 201 and a second vertical line 203. These services may also be accessed by conventional client-server interface devices as shown at the right of the dashed line 203.

The DVR or nDVR includes a processor for executing programs which performing data storage retrieval and for controlling the display, recording and playback of video programming using integrated electronic program guides. Conventional personal video recorders include, for example, the ReplayTV DVR described in U.S. Pat. No. 6,324,338 issued Nov. 27, 2001 entitled “Video data recorder with integrated channel guides” and the TiVo DVR described in U.S. Pat. No. 6,215,526 issued on Apr. 10, 2001 entitled “Analog video tagging and encoding system.” Controls for pausing, replaying, and fast-forwarding time-shifted television programming stored in a digital circular buffer are described in U.S. Reissue Pat. No. 36,801 issued to James D. Logan et al. on Aug. 1, 2000 entitled “Time-delayed video system using concurrent recording and playback.” In each of these arrangements, a programmed processor controls the recording and playback of video programming which is stored in digital form on a conventional hard disk drive. DVRs are increasingly being incorporated into the set-top-boxes (channel converters) provided by satellite and cable programming providers and utilize the electronic program guide provided by those services. The functional equivalent of the local program storage provided by a DVR may be achieved by video on demand (VOD) services which store program material at network nodes near subscriber sets and download selected programming over a broadband connection upon the request of the viewer or in anticipation of the viewer's probable future program selections.

As described in more detail below, the DVR is provided with controls that may be manipulated by the viewer, typically in the form of a remote control device coupled to the DVR by a wireless or infrared communications link. These interface controls typically operate in conjunction with the television screen display which provides menus, prompts and other visual displays to aid the viewer in performing three types of control functions: playback control as seen at 211, recording control as shown at 213 and content navigation as indicated at 215.

The playback control 211 controls the playback of stored video programming seen at 217, stored electronic program guide (EPG) data seen at 218, application data such as standard templates stored at 220, metadata describing programs and program segments stored at 221, and other system control data stored at 222.

The recording control 213 permits the viewer to utilize the EPG data 218 and the metadata 221 to control the recording of available content in the local video store at 217.

The DVR further includes storage at 225 for storing executable application program code and storage at 227 for maintenance information, usage data, etc.

The locally stored video and EPG data seen at 217 and 218 respectively in FIG. 2 are supplied from the live video source 230, typically a connection to a satellite or cable television provider (“MSO”), a conventional broadcast tuner, or some other video programming source indicated 231 which supplies programming and program guide content 232.

The application data 220, the EPG data 218, the metadata stored at 221, and the system data 222 may be downloaded via a data connection seen at 240, which may be the same physical communications link that supplies the live video feed 230, or a separate data link such as an Internet or dialup connection. The data download feed 240 is may be provided in part by a DVR support service which supplies EPG data 241 from an available EPG database 242 and a database for storing programming suggestions 243 provided by the DVR service. In addition, the DVR service may provide information such as the “To Do List” 244 to assist the viewer to perform certain tasks, and to control the DVR's performance of automated tasks such as recording selected programs identified by the DVR service.

Metadata stored at 221 in the DVR, and additional EPG, application and system data stored in the DVR at 218, 220 and 222 may be downloaded via the download connection 240 from the metadata service provider which provides a metadata update facility at 250. This facility is coupled to a file server 251 and/or a database server 252 for storing metadata including data describing individual program segments, playlists, as well as date describing products and services being offered to viewers, current pricing information, etc.

In addition, metadata contributed by other users and stored in a public database 254 as well as private metadata from a database 255 may be downloaded to the DVR by the metadata service's download facility 250. The metadata stored at 251-255 may be created, edited and deleted using a Web server 261 or other server 262 operated by the metadata service to permit the public (other viewers) to contribute to the metadata as illustrated at 264, as well as providing the ability for employees of the metadata service to create and modify the stored metadata as indicated at 265. Using the DVRs data upload facility seen at 250, usage data, “watch this” selections, playlists, data concerning viewer's purchasing decisions and instructions, and other user-generated metadata may be uploaded from the DVR via the user data submission facility 272 provided by the metadata service which may supply both the public and private metadata stores 254 and 255.

The executable program code stored in the DVR at 225 and the maintenance data stored at 227 may be updated through a maintenance data link 280 which receives program code and maintenance data downloaded from either the DVR service at 245 or from the metadata service provider as seen at 290.

Although separate storage areas are shown in FIG. 2 for storing application data, EPG data, video date, metadata, executable code, etc., it will be understood that all such data may be persistently stored on the DVRs hard disk from which it is loaded into RAM storage for use as needed, or may be dynamically loaded as needed via the data download pathway 240.

Each of the foregoing platforms is described in more detail in the above-noted U.S. patent application Ser. No. 10/165,587 filed on Jun. 8, 20002 entitled “Audio and Video Program Recording, Editing and Playback Systems using Metadata” now published as Patent Application Publication No. 2003/0093790 A1 published on May 15, 2003. As described there, and in other patents and applications noted above, metadata may be created by human editors or by automated techniques which subdivides a program, such as a broadcast sales program, into segments. The metadata identify the location and extent of each segment, and may include text labels or other descriptive information characterizing individual segments. Segments may be described with short text labels (called “slugs,” “tags,” or “labels”) which may be displayed as a segment “index” or “guide” on the television monitor.

For example, as seen in FIG. 1, a segment index seen along the left hand side of the screen contains a list of short text labels each of which describes a particular property being offered for sale in a sales presentation broadcast which has been recorded in local or network storage for on demand playback by the viewer. The viewer may use the remote to highlight a particular property description as illustrated at 115 by the dashed line rectangle around the label for a property in “Barnstable.” When that segment label 115 is highlighted, the playback of that video segment describing the selected property appears in reduced size in the upper right hand portion of the television screen as illustrated at 120.

At the same time, a second segment listing containing labels which list subsegments of the presentation concerning the “Barnstable” property appears below the video portion 120. As seen in FIG. 1, the subsegment label “Exterior” is highlighted at 110 to indicate that the portion of the property description which depicts the exterior of the property is currently being played back. The user uses the right-left navigation pushbuttons on the remote control to switch the highlighting between the property segment index listing and the “within property” subsegment index, and then uses the up-down navigation buttons on the remote control to select a particular segment or subsegment in the two lists.

The segment and subsegment index and other “guide” or “menu” displays may consist of a “transparent overlay” of which shows all or part of the segment labels that make up the playlist as list of text labels that overlays a full screen presentation of the content. The particular label of “slug” that describes the currently playing segment is preferably highlighted in some fashion as illustrated at 110 and 115 so that the user can visually associate the segment currently being played with the items on the list. By using the remote, the viewer can move an on-screen “cursor,” or move the highlighted selection 115 to a different segment label and then, using the select button or the like, switch the playback to the selected segment. If the segment list is longer than the space allotted on the screen, it can scroll so that the highlighted segment label remains visible on the screen. Note that the segment label selected by the cursor may be indicated by one form of highlighting (e.g. a special text or text background color) while the segment label for the segment being viewed may be identified by a second mode of highlighting, such as a graphical pointer or icon positioned at the playing segment label. The highlighting mechanism may change to provide additional information as a navigation aid. For example, when a subsegment showing the “Interior” of a property is being replayed, an small graphic showing a floor plan may be displayed and different portions of the floor plan wound then be highlighted during the “Interior” subsegment of a property presentation to indicate which room within a house is being shown, and the viewer could selectively highlight different rooms for which video was available using the remote's navigation cursor to view or replay specific room descriptions.

As shown in FIG. 1, the screen display may also be divided into panels containing information and menus. The video image or “picture” of the segment being played is reduced to the size shown at 120, making room for a vertical panel at to the left of the picture which contains a segment list segments adjoining the segment currently being played, as well as room for an information panel below the picture. In the example screen seen in FIG. 1, a text description of the property being viewed appears at the lower right at 130. The separate panels insure that the metadata-based information displayed on the screen will be readily visible, which may not always be the case with overlaid characters, and that the added information will not obscure the picture.

It should be noted that the viewer may elect to return the display to an unobstructed full screen view at any time, and likewise may redisplay the paneled version at any time that the user wishes to view the extra information provided by the metadata, or to navigate to a new segment, or perform some other function. In the full screen mode, the short “slug” or a longer description of the segment may be shown (or not, as selected by the viewer) in much the same way that close-caption text appears on screen when requested.

The information panel below the video portion may also be used to present advertising, which may occupy all or part of the information panel, depending on the need to present other information.

In accordance with the invention, playlists supplied by the content provider such as a cable VOD or satellite provider, or the content provider that produces a sales presentation, such as a real estate service, or a retail sales channel like “QVC”®. the Home Shopping Network”®. or “Shop at Home TV”®, can be used to control the presentation of a special version of presentation. For example, a real estate presentation can be viewed which limits the segments played back to those relating to properties in a particular price range, with a particular number of bedrooms, or in a particular location. Playlists for product can be devoted to particular price ranges, to products of interest to a particular gender or age group, or in a particular category. When a playlist is selected, program segments are listed in the segment index or guide in the order in which they will be played back in the absence of user intervention. Specific playlists are selected by using the remote navigation bar to present a menu listing of available playlists, from which the user selects a given playlist to be activated which will then control playback.

As illustrated by the subindex which is highlighted at 110 in FIG. 1, individual segments in a sales presentation may be further indexed allowing the viewer to quickly access individual aspects of that segment presentation. Ideally, each video sales segment would have a similar structure allowing the shopper to develop a mental model of attributes across which he or she could compare houses or other products. Thus, using the subindex seen in FIG. 1 as an example, the sales presentation for each property would begin with a subsegment devoted to the exterior of the house, followed by subsegments devoted to the interior, to other features of the house, to information on pricing, rental rates, and/or financing, and would conclude with an identification of the particular broker to be contacted if the viewer wants more information. Note the content of the subindex listing may change from property to property, but all segments should conform to the standard structure where possible to match the viewer's expectation of what information will be made available.

The system could employ a double-tier Next button navigation control. That is, one button on the remote would skip from house to house or the segment index at the left, while another remote action would jump the viewer to the next subsegment presentation within a given house presentation. This could be implemented as two different remote control or two on-screen interactive buttons, a single button that could cause different actions based on one click vs. two rapid clicks, or a single up-down, left-right navigation control that shifts the highlighting from list to list, and from item to item within a list. Another preferred implementation would be to have the vertical navigation arrows move the viewer from house to house, while the left and right arrows would move the viewer from item to item with in the sub-segment listing about each house.

A further mode of playback navigation employs a “skip” button which allows the viewer to skip to from the current playback position to the beginning of the next segment or subsegment, depending on which list is currently highlighted. For example, when a viewer decides she has no further interest in a given property, she may skip immediately to the beginning of the next house presented in the original broadcast (or the next house on the currently playing playlist). One mode would allow the viewer to select a subtopic (e.g. “kitchen”) and then skip the current playback position to that subtopic in the next topic. This would allow the viewer, for example. To see a kitchen in one house, and upon hitting the skip button on the remote, be taken to the beginning of the kitchen segment in the next house in the original program or playlist, thus looking at each house's kitchen, skipping from one to the next at will.

There are two leading ways to construct the shopping playlists. In one scheme, the playlist would represent all or selected parts of a stored version of a broadcast show. In another scheme, the metadata provider would assemble segments over time and concatenate them to make playlists. Thus, segment-viewing can be achieved either by segmenting linear broadcasts or stringing together or assembling segments which may be fetched on a demand basis from an on demand system when the pre-assembled playlist is selected for viewing.

The metadata which identifies segments includes the content of the descriptive tag information used for segment and subindex segment listings and descriptions, supplemental information concerning the products or services offered, as well as advertising and other content, that can be presented when the segments are viewed. For example, as illustrated by the text at 130, additional details like square footage of the dwelling and lot size, and much more, could be displayed. This additional metadata might be displayed in a number of ways: on one or more additional “Info Screen” accessed via a remote button; as a text crawl across the bottom or the top of the screen; or the space below the video portion sometimes occupied by the banner ad graphic as illustrated at 130. Both the index and the additional descriptive metadata may be presented around a “shrunk and wrapped” video image, or via transparent or opaque overlays over the original-sized image.

As some viewers would value the features shown in some segments over others, the viewer could be given the ability to set up a viewing template allowing the sub-segments for each house to be presented in a certain order. Thus, although the original sales presentation content would be broadcast in a modular way in an order determined by the broadcaster, the sub-segments could be reordered, and some segments deleted, to conform to the viewer-defined template, so that the sub-segments could be viewed out of order and only desired segments shown, while still having a smooth flow.

The viewer would have access to a set up menu to construct this template. This set-up menu would initially show each segment type in the order the producer had deemed most appropriate. The viewer, however, could then highlight any given segment, select it, and then hit the up or down arrow to move it to a different spot on the list or another arrow to delete it from the list. Alternatively, the viewer could also use a voice-activated remote or device or pointing device to rearrange the list. This and other set up procedures in which the user specifies preference control the manner in which content is presented can be performed using a personal computer to access a web site. In this way, the metadata that is downloaded to the subscriber to control the TV presentation may be specially written to conform to each subscriber's preferences. In addition, preferences and playlists can be reconstructed “on the fly,” should be possible, and a software executable by the subscriber permits reconstruction of the templates and playlists currently stored.

Shopping by Process of Elimination

Most of the commerce areas in which the system would be used involve purchases of a singular item. Unlike buying items using an Internet online sales site, such as Amazon.com®, where the site assumes multiple purchase may be made and recommends new ones based on others purchased in the past, the purchase of a house, car, or boat will typically be a singular event. Thus, the primary goal of the video-shopping system for presenting such items would be to reduce the selection list down to a short list. For such item like houses or cars, it is unlikely that the purchaser will make a final buying decision from the video presentation alone. The system therefore relies on multiple perusals of lists and annotations of the list as the viewer progresses, in order to produce a short-list of candidates that may be visited in person or discussed with a broker or spouse. Because it is likely that a viewer may wish to later refer to, or replay, items of interest with another, and may accordingly wish to bookmark or annotate items of interest, mechanisms which permit the user to create and store such metadata are used, as described next.

Adding Metadata

When viewing houses, multiple forms of user tagging could be used to annotate the list. Such annotations could create either a “positive action” by adding items that had been user-tagged in a certain way to a “Wish List,” or a negative action by deleting items user-tagged in a negative way from the master list.

The Wish List could be further broken out by letting viewers assign houses to one of several categories, such as: “must see”, “worth another look”, “questions”, etc. A “Wish List” is patterned after, and can indeed take the form of, a user-generated playlist discussed earlier. An automated mechanism for adding items to a wish list may be employed; for example, any item being offered that a view watches without skipping to the next item could be added to a growing wish list on the assumption that the item which was viewed was “of interest”.

A user-generated marking tag could also be associated with a segment or sub-segment. Such a “Segment Interest Tag” could be easily generated while reviewing a segment or sub-segment by simply hitting the appropriate key on the remote or saying a command into a voice command recognition device.

Such tags can include a numerical ranking. That is, hitting a key or keys on the remote, or speaking a number, could create a 1-10 score. Such a granular scale would allow the viewer to keep a well-ordered list going as window-shopping progressed. The user could then request the playback of, or create a playlist containing, all segments having a designated ranking (e.g. all segments ranked above “5”). In this way, the user may tag items of interest and later control the extent to which those items are reviewed.

Tags, including tags containing ranking data, may be used one attribute of a general segment filtering mechanism. Thus, for real estate, the user might request the creation of a playlist containing all houses is a stated location that are also in a stated price range and which have been tagged with a ranking value greater than a specified number.

For voice-enabled systems, each segment and sub-segment could also be annotated with a viewer's voice comments. These voice comments could be programmed to play each subsequent time that a segment played, or the existence of the voice comments could be indicated with a visual symbol allowing the viewer to selectively play comments. In addition or as an alternative to voice comments, the segments could be annotated with user-provided text, typed in via an on-screen keyboard, dictated via phone to a voice-mail system and then manually typed in by a third party, dictated via phone to a voice-recognition system, typed in via cell phone and then transmitted to the cable system via SMS, entered via an IR-connected keyboard, or entered via a Internet-connected PC.

In addition or as an alternative to voice comments and text annotation, the segments could be annotated with user-provided digital still pictures or digital video. For example, a user might go visit one of the houses presented in the service, snap some digital pictures, and then later annotate the house on the service so that he/she would remember positive or negative details of the house that are not apparent in the on-demand video. Digital picture and/or digital video annotations could be added to the system by the user themselves, by uploading the media via their digital set-top box or via an Internet-connected PC. Otherwise, the user might send the digital media to the service or a third party to post the annotation on behalf of the user.

All annotations and user-contributed metadata would be for the personal viewing/perusal by the end user, but could also be made available to other users by the person doing the annotating. For example, a broker might make his/her annotations available to all his/her clients; a seller may make annotations available to all viewers; an individual may make annotations available to his spouse or relatives. Password access could be used to give relevant parties access to this metadata. Ranking data (or implied ranking data generated automatically based for example on the extent to which segments are viewed but not skipped) can be used to create “public ranking” data, so that, after a broadcast has been available for a time, viewers can view only those segments having a public ranking greater than a specified value.

Metadata associated with the items being perused would in general be persistent according to a user-set level. In general, metadata associated with segments which continue to be stored on behalf of a particular viewer on local or network storage would also continue to be stored for as long as the content segment continues to be available. Likewise, playlist would continue to be stored as long as a significant portion of the segments specified on the playlist continued be available. In the event the user requests the deletion from storage of a saved segment, a warning may be issued if that segment is identified on one or more playlists which the user may wish to retain intact. However, the user could establish a time period after metadata is discarded. For example, wish lists may be automatically discarded after a stated time, even though the segments identified on the wish list remain in storage.

A special command, should allow a subscriber to globally clear all user-provided metadata, including tagging, ranking, playlists, and wishlists. In addition, it is desirable to include a mechanism which would permit a user to “undo” any recent deletions (e.g. to provide a facility like the Windows® “recycle bin”), or to reset the metadata to a status that existed at a prior time.

Note that user-generated metadata which is placed in network-accessible storage my be associated with a user account, such that the user could log in using a different set-top box (e.g., one at their broker's office) and get their personalized presentation of the on-demand content, annotations, and metadata. Also, this user-metadata, annotations, and content could be bridged between MSOs using the same metadata service, so that when a user switched providers, they would still be able to access their personalized presentation, as long as the new MSO carried the service.

The system should also allow the shopping list of two or more shoppers to be merged together. Merged lists could be displayed as separate lists and just presented on-screen simultaneously. Alternatively, merged list could be truly merged with the ranking and/or ordered of each list affecting the ranking and/or ordering of the single merged list.

In merged lists, the rankings and/or annotations of various users could be displayed in different colored text, have different icons associated with them, have the name of the contributing-user present, or otherwise be displayed in such a way that viewers could ascertain which user had contributed which ranking and/or annotation. At any point, viewers could then cause the merged rankings and/or annotations to appear the same (that is, without the indications showing the contributing-users).

When separate lists are merged and displayed, different users' rankings and ordering could be treated with equal weight relative to each other and affect the merged list equally, else one viewer's ranking and ordering might be valued more or less than another user's and have more or less affect upon the merge list, For example, in the latter case a shopper may value the opinion of a third party (e.g., their broker), and wish to see what that person thought for informational/validation purposes, but not wish for the third-party's rankings to actually affect their own ranking and/or ordering.

Alternative to merging completely separate shopping lists, two or more shoppers might work upon the same list at different times. The first shopper could perform ranking, ordering, and/or annotations, and then another shopper could be selectively allowed to further refine the shopping list. The second shopper could do so with or without the benefit of seeing what list modifications the first shopper had applied. The affect of multiple shoppers against a single list could be equally weighted; else one shopper might be valued more or less than another shopper.

Another potential mechanism for weighting and taking into account different opinions could be to setup a “family account”, that can be accessed by any permitted party, which may include multiple people in a family and a broker. Then, the user can login to the family account and specify which user they are, creating rankings that are specific to their person. The shoppers can then filter the list according to any permitted user, be it a spouse or a broker. Likewise, the index view might user colored symbols to indicate a recommendation by a particular person. One could envision a single item on the index having one or more indicators of some concerned party's preference. In this case, quick scanning of the index might allow the current user to see what properties multiple parties preferred.

Non-Viewer Metadata

All user-generated metadata could be associated with a specific member of the “buying team” (typically a couple residing in the same house, but it could encompass two or more individuals spread across multiple households). The source of given input metadata could be overtly entered into the system at the time of its creation. For metadata created via voice input, the identity of the speaker could be deduced by the system using voice-identity algorithms. Such deduction could just be relative, that is, it could merely distinguish one speaker from another but not really know the identity of either. The voice input module could be adapted to do this.

Metadata could also be created by an outside party, specifically, a broker. In this scenario a broker could access the database and put together a video tour for a customer or prospect. An access code could be given to the selected viewer who could then access a playlist of suggested houses. Alternatively, this broker-generated playlist could be open to the general public. Other parties could create and post playlists as well. An element of the business model could result in brokers or others being charged to create and post such playlists.

Neutral third parties could also provide extra metadata, annotation video, and additional voice-over as a service to buyers. Similar to inspectors, but less rigorous, these third parties could provide un-biased reviews of houses. Buyers might pay a premium fee for access to this additional information.

The MSO could also help create metadata, as the MSO would have the address of the set-top box. With this information, mapping metadata could be integrated into the system, for instance, telling someone watching a house, how far away it is and even directions for getting there. There could also be a Tour Button, which would invoke a “traveling salesman” algorithm to suggest the best route to take to visit multiple houses in one trip.

Metadata, ordering, and ranking could be automatically suggested by the system, based on user-profiling and collaborative filtering. That is, based upon what a user has liked or not liked in the past, and what other viewers are liking or not liking, the system could automatically pick out certain content and/or segments and highlight these to the user, either in a separate playlist or intermixed with the user's self-ordered/self-ranked presentation.

The viewing statistics related to a house (e.g., the number of users who viewed a particular house in a given period, the number of users who added that house to his/her Wish List, the ranking of the house relative to other houses, etc.) could be made available to viewers and/or sellers, possibly for an additional fee. Also, there could be a “Top Listings” playlist, where the most viewed, most “Wish List-ed”, or otherwise most popular houses are shown.

Item Display

As a picture may be the most informative way to present and list a house, a car or other product, or a service, such as a restaurant, a metadata “table of contents” page, or a set of pages arranged in sequence or in a hierarchy, may consist of as a screen full of still images of products (e.g. pictures of the front of houses). When the user navigates to a still image, that image might automatically start playing as video instead of showing just a still picture, and/or it might be highlighted in some way (e.g., yellow rectangle surrounding it). The viewer would then navigate to the house of interest and click, at which time the picture mosaic could disappear (full screen mode) or be reduced to a row across the top or along the side of the screen (index mode) as illustrated in FIG. 1. The viewer could navigate the bar of thumbnail photos much as one navigates the index of text labels seen in FIG. 1. A table of contents page or pages could be automatically constructed for each playlist so that the viewer could jump to and begin the playback of a playlist at an entry point selected using the table of contents page.

Viewers would be able to construct a list of houses to peruse by using sorting tools that would organize the list by town or some other attribute or combination of attributes. Sorting could be based on static attributes that the user sets through a configuration screen (via on-screen TV pages or an Internet web page). In this way, if something like location were always of prime interest to the user, presentation to that user would always be presented as sorted by location. Alternatively or in addition, the user could dynamically sort and re-sort the listings based on attributes. Such sorting could happen before the listing is displayed (much like an attribute-based search is performed on Internet web pages), or after the listing is displayed (much like email in-boxes can be sorted based on headings like Date, Sender, Subject, etc.). When, for example, a playlist containing real estate presentations is available, the playlist could be sorted before playback to present the properties in order by ascending or descending price, and the table of contents page and the segment index for that playlist would be sorted accordingly.

In coming up with the user's desired and/or required attributes (e.g., price, location, amenities, features, etc.), and the relative ranking of those attributes, the system might probe the user with direct or in-direct questions (e.g., “Is it more important that the house have a garage or a spare bedroom?”). Based on the user's answers to these questions, the system would construct the weighted sorting and/or filtering attributes that would affect the presentation to that user.

As viewing each house might take several minutes, the viewer would further be able to edit the list even before starting to view it. Editing the list could be done by deleting houses from the table of contents list or from a segment list (based on the still image or other text metadata shown about the house in the opening screen), or by reordering the list (in the same manner that the template's list of segments can be reordered, see above) so that the items could be viewed in a certain order.

The system could present the secondary index for each house (Exterior, Interior, Features, etc.) once a house is selected. The user could navigate to that secondary index, or get there by default. Once focus was on this house-specific index, the viewer could navigate from segment in the usual manner—either by hitting the “next” button to skip forward, or by navigating down the list and selecting.

The system would also accommodate fragmented viewing. That is, a mode of operation where the viewer might come back time after time to review the list. To help viewers using the system in this mode, there would be some visual cues as to which houses had already been viewed (by that particular viewer). Alternatively, each viewer or member of the buying team could have a bookmark placed at the spot where they left off, or multiple bookmarks if they had worked their way down more than one branch of the hierarchy of choices.

Intermittent viewing would also present the problem of new items having been introduced since the last viewing. These could be singled out for special review if they would normally be presented in a part of the hierarchy that the viewer had already combed through. This could presented as an annotation (e.g., a “new” icon or similar text adjacent to the segment tag), or simply through a “New Listings” playlist. In the latter case, the listings could stay in the New Listings playlist for as long as it took the user to review them (like an email in-box), or else the new listings would be cycled in/out on a regular basis.

Selection

To help winnow down the list of houses, various tools would be offered to delete, or “back-burner” less desirable houses, and highlight or pick desirable ones. This sorting could be done in real-time as the viewer inputs metadata, such as a ranking tag. Such selected houses could be added to a second view-bar of still images comprising “Houses of Interest” that could appear across the bottom of the screen or elsewhere. This list of houses could be sorted by date added or quality of house if numerical metadata was used or could be manually sorted by the viewer.

The still picture of a house shown on the bar of selected houses could be modified to show the still image associated with the segment that was tagged Of Interest. For instance, if the swimming pool was of keen interest to a viewer, the Interest button could be pressed while that content was being viewed or highlighted on the index. The still image associated with that segment would now become the signature still image for the entire house. Alternatively, or in addition, the user might modify the segment tag text itself. For instance, the user could replace the text from “4Bed/2Bath Boston $429K” to “Green fixer-upper” or “Gorgeous kitchen!!!”

Combining the idea of a list of “Houses of Interest” with others above, it can be seen that a fully implemented interface might result in three lists appearing on the screen at once: The filtered list of houses represented by still images, which might show just a subset of the houses in the “Candidate” list (some just recently viewed and those next up in the list); the index of segments for the currently selected house (Exterior, Interior, etc.); and the “Houses of Interest” list, which would be comprised of the still image that represented the house in the “Candidate” list unless it was modified by the viewer. The viewer, using some simple on-screen tools, could manually reorder and sort the “Of Interest” list.

“Compare” Functionality

Another mechanism for winnowing down the viewers choices is by use of the “Compare” function. This function can take any currently displayed list of houses, such as the viewers “Of Interest” list and display a chart on the screen with the relevant stats of each house. This is similar to various comparison-shopping options now offered on the Web, but implemented using the video commercial sales system embodying the invention. The user can seamlessly switch between an overall comparison chart and specific details about selections.

The comparison chart can include all of the commonly relevant features of a house, such as number of rooms and bathrooms, cost, square footage, etc, in addition to user-specified features like an in-ground pool or a 3-car garage. The chart can then be reorganized according to any of the features on the charts.

While viewing the chart, the user can approach selections from two directions. First the user can negatively filter specific houses for exclusion from the “Of Interest” list, thus continuing to narrow down possible selections. Alternately, a user could choose a positive filter function, where only selected houses remain in the “Of Interest” list, automatically excluding others.

The inclusion and exclusion filters could be applied to specific houses or to sets of houses. For example, the user could determine that all houses with three or more bathrooms should be included, while all houses above $400,000 should be excluded.

The viewer's ability to quickly and easily create a manageable list of purchasing options is a key factor to the utility of the system. As implied previously, at any time, the viewer can switch back to the normal shopping mode, using the video tours and other searching and filtering tools. The comparison tool simply allows for quick and easy narrowing with an overview chart that contains key data.

The chart may also contain a picture for each property that can be the same as the main picture in the video selection menus, that is, it can be the default home image or the user-determined picture.

The Filtering Algorithm

Ideally, viewers would first select a potential location for their home and a type of home (e.g. condominium, single family, two family, etc.). Location could be variably sized, allowing large areas such as “Greater Boston” or small areas, such as “Winter Hill Area in Somerville, Mass.”. Further classification and reduction could be based on various features, including number of rooms, number of bathrooms, price range, etc.

Features could be designated as “required” or “desired”. Every house on a viewers list should have the required features, but the list could be ordered to give preference to those with desired features. Desired features could be given ratings by the viewer allowing for a points-based approach to ranking the available houses.

Viewers could also rank or grade individual houses when reviewing them. This “interest metadata” could be used in a “self-collaborative filter” mode where the system would try to deduce which houses might also be of interest given the interest shown in the currently viewed house. With such a system, the housing options could be re-ordered in a dynamic fashion. For example, if the user ranks a three-story Victorian highly, the system may re-order the list to place other Victorian homes higher than similarly features Colonial homes. This dynamic playlist adjustment would act in a similar manner to a realtor who attempts to show a potential buyer homes that they would like, as they learn the buyer's preferences.

Another method for viewing, ranking, and selecting houses could allow the viewer to see only one particular feature of each house as a “filter” of sorts. For example, for some people, a certain type of kitchen could make or break a house purchase regardless of everything else. If the viewer could skip from kitchen to kitchen and pre-filter the list of homes quickly, the other features will be allowed the relevance they should have. This idea was explored earlier in the discussion regarding reordering the template.

Advertising

It is anticipated that the application would have various forms of advertisement placement in a manner similar to that described in the above-noted U.S. patent application Ser. No. 10/165,587 filed on Jun. 8, 20002, including banner ads, interstitial video ads, sponsorships, etc. The specific format of a sales presentation provides the opportunity or targeted “content-related” advertising associated with certain segments of the house. Thus, advertising for locally available yard maintenance services may be displayed while the “Exterior” subsegments are being displayed, while advertising for mortgage services might be displayed when “Financing” subsegments are displayed. Ads could also be bought for types of homes (old homes might draw ads from renovators), different prices, or different locations.

Ads could have a back-end and/or response components. Specifically, the response mechanism may be “passive” so that the advertisement contains a phone number or URL, and it would be up to the user to initiate contact for more information, purchase, discount, etc. Alternately, the metadata may specify an active link that is activated by the viewer's action (e.g., selecting the ad, viewing the ad, answering a question, requesting information, or otherwise engage with the system), whereby the system would initiate contact (e.g., sending the user an email, sending the user direct mail, calling the user on the phone, or initiating an on-screen interactive Web session, or activating a Web Service).

As the system may well know something about the address and demographics of the viewer, ads could also be personalized to the viewer based on the usual demographic information, as well as location. This targeting based on location might be less than useful however, as the person would presumably be moving. However, for some viewers, learning about houses in their current neighborhood may have a separate entertainment appeal.

The banner ad itself (or another screen associated with the banner ad) could be dynamic, in the sense that it could be populated with real-time information, such as current interest rates on a 30-year fixed mortgage.

Link to the Web

Viewers could input their email addresses into the system (or the system could get them from the MSO) allowing the service to “follow-up” the TV shopping experience with a parallel interaction on the web. Thus, the “Houses Of Interest” list developed on the TV could be set-up as a web page that the viewer could be directed to visit. There, the viewer would see more detail about each house, use the 360-degree viewing tool available on some home sites, and use other web-related resources. The viewer could explicitly denote those houses for which he wanted to follow up on the web.

Alternatively, a viewer could go to a parallel website and manipulate the list there. They could further export the results of that review of houses (which might have resulted in a “Houses of Interest” List, for instance) to the system so that when they went to their TV they could see full screen video for the houses they had targeted with their web search. In this way, the web is used for intricate searching and data-intensive perusal, while the TV is used to supplant or reduce the actual number of physical visits to houses by getting a virtual tour via video first. A third party, for instance a broker or spouse, could also do work on the PC.

Production of Videos

The invention envisions various ways of having videos produced and loaded onto the system. The most automated way to do so would let individuals, brokers or others to produce their own video and email it to the system where it would be uploaded automatically. Eventually, a standard would evolve for placement of the metadata that would allow such outside party to include the index with the video.

Another method would allow for such uploading to the VOD system, however, the material would also be downloadable from the web. In this way, the seller/broker could go to the web and use a simple web-based application to create an index, input other metadata, and/or edit the video. The resulting completed indexed video would be automatically loaded onto all the relevant VOD head-ends.

Alternatively, a similar editing application could be offered over the VOD system itself for use by a seller, who would input a password or number to access the unprocessed video. A simple set of functions would be offered that would enable the video-owner to add an index, remove portions of the video, reorder segments, etc. These commands could involve the use of a TV remote control, a wireless keyboard, or voice input.

Another method would blend together web and VOD approaches. In this case, the user would email or otherwise send the video to the system, along with a text file comprising the index. The video owner could then access the unprocessed video via a password, which would have been emailed back to him. The VOD system would then present on his screen both the raw video and the unassigned segment “slugs” or labels. The video owner could use the remote control to indicate where the beginning of each segment was and thus synch up the index with the accompanying video. This approach, because it presents the video to the user over their TV screen, would not require any broadband access.

If, for some reason, these methods were unavailable to the user, videos could also be physically mailed on tape to the service and mark-up could be determined and performed entirely by the service.

Real Time Data

The system would allow real-time, or near-real-time data to be integrated into the system. This would allow information to be displayed such as “Under Contract”. Such transaction-related metadata would be necessary to show that transactions were truly happening that were related to the system. New prices could also be shown, as could the number of VOD-views, the number of viewers who had put the house into the “Of Interest” category, or annotated the listing for their own use.

Another use of real-time information would be to schedule house visits for those homes being sold by the owner. The owner would have either a VOD, web-based, or cell-phone tool that would allow them to enter the times that they were available to show the house. Viewers could be presented with these available slots and could sign up for a viewing slot using their remote or by going back to a web-related tool.

Viewers signing up for visits could enter their email address (or it could already have been entered) and receive confirmation of an appointment via that means. Alternatively, the VOD stream itself, could communicate a confirmation onto the TV screen.

Alternative Business Models

Another business model associated with the production of the video would be that the entity offering things and services for sale would supply the video content, and the sales presentation producer would edit and the combine the supplied video content, create the voice over, and build the index and other metadata. A separate price could be charged for such service. In certain instances, the video owner could submit their own voice-over and that audio content could be redone based on what the video owner attempted to communicate on their own.

Alternatively, for an additional fee, the service could provide professional video producers and camera operators to go on location to shoot and produce the video. The service's production crew might also provide the on-screen talent, should the house owner (or their representative) not wish to appear in the video segment.

Finally, the service could set up a network of video-graphers across the parts of the country where its service was offered. This individuals and companies would have been vetted for quality and have agreed to perform services at pre-determined prices. Prospective sellers could go to the system's website, or those of our aggregation partners, and locate these video-graphers by typing in a zip code. Scheduling of the shoot could be done over the web. In addition, viewers of ads on VOD would be able to access via their remotes the identity of the video-grapher who shot a specific video, along with contact information. A full directory would also be available along with a cross-reference, and access to, the video segments that they had produced.

This directory-like service could also be used to relate other videos to relevant resources. For instance, a viewer could access a list that would show the brokers represented on the system. In the case of brokers or video-graphers, this attribute could be used to construct playlists of houses. That is, a viewer could click or select a particular broker, or set of brokers, and a playlist of houses proffered by them would be constructed and presented to the viewer.

Other aspects to the business model which supports the creation of the needed content and metadata includes the various ways that the MSO could charge for the storage and access to the VOD server. That is, the cost of placing a house on the server could be a function of the amount of storage taken, the duration of the placement, the reach of the placement (that is could it be seen all over Los Angeles or just in certain areas). Other factors involved in computing a price would include where in the playlist the house was placed, the number of playlists in which the house appeared, whether the house was shown as a still ad or video, how long the house was kept in the New Listing playlist, whether the house was featured in a barker video or a special Spotlight playlist, and the level of indexing or other features that were offered. Charges could also be based on how many viewers accessed the property, how many viewers tagged the house in some way, or whether the house was sold to someone who saw the video. Commissions could also be charged for houses sold after being seen on the system.

In addition to splitting advertising revenue with the MSO, advertising revenues could also be split with the home seller. That is, placements that allowed ads to be placed in conjunction with their property would enjoy a cheaper placement fee. The advertiser would be allowed to specify how many banner ad slots available with his video would be devoted to ads versus displaying additional information about his house. In the case of video-type ads, the house owner could decide on the number of such ads-from zero to a maximum threshold that the system sets.

Generally, the service would be free to viewers (that is, potential buyers). However, additional services could be offered to viewers for an additional fee. Examples of these additional services include: viewer annotation with text, pictures, or video (described above); “sneak peek” viewing of new listings before other viewers see the new houses; ability to make appointments to visit the house in person; access to additional information such as inspection report text and pictures, or access to a video walk-through with an inspector; ability to communicate with the seller via the system;
Melding the Marketplace

Another novel aspect of the business model is the way that the service could meld together the VOD systems of adjacent MSOs to make a common market. Today, for example, both Time Warner and Comcast serve Boston. To create a “video home marketplace”, it becomes important that as many buyers as possible have access to the marketplace, and is hence desirable that sales presentations containing descriptions of Boston real estate be accessible to viewers using either MSO.

To solve that problem, the service would set up similar systems on adjacent cable systems and orchestrate them so that they appeared as one marketplace to the sellers. Thus, a seller could post a house for sale, and it would appear simultaneously across the whole market, giving everyone equal access. Brokers putting together video tours would not need to worry about which cable operator the customer used.

For those customers who did not have cable, or who were coming from out of town and didn't have access to the video material, a service would be offered whereby the video tour could be could be accessed via the Internet, or put on a DVD. Ideally, this would work with a DVD player of the type noted above that is adapted to respond to stored metadata. Such players could be rented by the service or by brokers.

Once spot-beam satellite technology has evolved to be able to offer reasonable local content, satellite DVRs could be used to collect such house video content overnight. The UI could be downloaded as well via a similar download.

Additionally, the service could be accessed via kiosk devices placed at relevant loactions (e.g., broker offices) or high-traffic areas (e.g., malls).

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A method for presenting a televised sales presentation broadcast which comprises, in combination, the steps of:
recording a sales presentation to create a video program stored in a program storage device, said sales presentation including a plurality of program segments each of which describes a particular object, product or service that is being offered by one or more vendors,
creating metadata that identifies and describes each of said plurality of program segments of said video program as stored,
transmitting said metadata to a presentation device,
displaying a segment guide containing information in said metadata on said presentation device, said segment guide including elements which identify at least selected ones of said plurality of segments,
employing a control device operated by a viewer and coupled to said presentation device for selecting a specified one of said elements,
retrieving the particular segment identified by said specified one of said elements from said storage device,
transmitting said particular segment to said presentation device, and
displaying said particular segment for said viewer on said presentation device

2. A method for presenting a televised sales presentation broadcast as set forth in claim 1 wherein said metadata further stores a group of one or more metadata playlists, each of which identifies a different plurality of segments of said video program as stored, said method further comprising the steps of displaying a description of each playlist in said group, accepting a designation of a specified one of said metadata playlists from said control device operated by said viewer, and for thereafter displaying segments identified by said specified one of said playlists on said presentation device.

3. A method for presenting a televised sales presentation broadcast as set forth in claim 2 wherein said plurality of segments identified by said specified one of said playlists comprises substantially less than all of said program segments in said sales presentation whereby viewing said plurality of segments designated by said specified one of said playlists provides said viewer with a condensed version of said sales presentation.

4. A method for presenting a televised sales presentation broadcast as set forth in claim 1 wherein at least some of said program segments are subdivided into subsegments, wherein said metadata further identifies and describes each of said subsegments, and wherein said method further comprises the step of displaying a subsegment guide containing information in said metadata which describes the subsegments contained within a designated one of said segments.

5. A method for presenting a televised sales presentation broadcast as set forth in claim 4 wherein said designated one of said segments is said particular segment currently being displayed for said viewer on said presentation device.

6. A method for presenting a televised sales presentation broadcast as set forth in claim 1 wherein said sales presentation includes a plurality of program segments each of which describes a real estate property being offered for sale or rent.

7. A method for presenting a televised sales presentation broadcast as set forth in claim 6 wherein at least selected ones of said program segments are subdivided into subsegments describing different categories of information concerning the real estate property described by said selected ones of said program segments, wherein said metadata further identifies and describes each of said subsegments, and wherein said method further comprises the steps of displaying a subsegment guide specifying said categories of information and employing said control device operated by said viewer to select and display the content of one of said subsegments listed in said subsegment guide.

8. A method for presenting a televised sales presentation broadcast as set forth in claim 1 wherein said sales presentation includes a plurality of program segments each of which describes a particular object, product or service of the same kind, said same kind being selected from the group comprising:
real estate properties together forming a televised real estate sales presentation,
vehicles together forming a televised vehicle sales presentation,
retail goods together forming a televised retail sales presentation,
restaurants together forming a televised restaurant dining guide,
travel destinations together forming a televised travel guide, or
events together forming a televised event planning guide.

9. A method for selecting and playing individual segments of a recorded video sales presentation program comprising, in combination,
receiving from a media provider metadata comprising a plurality of segment descriptors, each of which specifies a specified segment of said recorded sales presentation program that describes a particular object, product or service being offered and at least a text description of said object, product or service described by said specified segment,
displaying a composite image on a display screen consisting of:
a video image area for reproducing the video content of one of said segments of said recorded sales presentation program, and
a segment guide area displaying said text description of said object, product or service described by each of a plurality of said segments,
accepting the identification one of said plurality of segments from a viewer operated control device, and
displaying said given one of said plurality of segments in said video image area.

10. A method for selecting and playing individual segments of a recorded video sales presentation program as set forth in claim 9 wherein said video image area occupies only a portion of said display screen and said segment guide area occupies an area of said display screen outside said video image area.

11. A method for selecting and playing individual segments of a recorded video sales presentation program as set forth in claim 9 wherein said video image area occupies only a portion of said display screen, wherein said segment guide area occupies an area of said display screen outside said video image area, and wherein said method further comprises the step of displaying additional information in an information area which occupies an area of said display screen outside both said video image area and said segment guide area.

12. A method for selecting and playing individual segments of a recorded video sales presentation program as set forth in claim 11 wherein said additional information describes said object, product or service described by the segment currently being reproduced in said video image area.

13. A method for selecting and playing individual segments of a recorded video sales presentation program as set forth in claim 12 wherein said information area further displays advertising.

14. A method for selecting and playing individual segments of a recorded video sales presentation program as set forth in claim 11 wherein said information area further displays advertising.

15. A method for selecting and playing individual segments of a recorded video sales presentation program as set forth in claim 11 wherein said additional information contains a supplemental text description related to the object, product or service described by that segment currently displayed in said video image area.

16. A method for selecting and playing individual segments of a recorded video sales presentation program as set forth in claim 9 further comprising the step of storing a group of one or more metadata playlists, each of which identifies a different plurality of segments of said recorded video sales presentation program, said method further comprising the steps of displaying a description of each playlist in said group in said segment guide area, accepting a designation of a specified one of said metadata playlists from said viewer operated control device, and for thereafter displaying segments identified by said specified one of said playlists in said video image area.

17. A method for selecting and playing individual segments of a recorded video sales presentation program as set forth in claim 16 wherein said video image area occupies only a portion of said display screen and said segment guide area occupies an area of said display screen outside said video image area.
